(19) United States
(12) Patent Application Publication
(10) Pub. No.: US 2021/0221384 A1
(43) Pub. Date: Jul. 22, 2021

(54) SYSTEM AND METHOD FOR EVALUATING RECORDED VEHICLE OPERATION DATA

(71) Applicant: Aravind Musuluri, Houston, TX (US)

(72) Inventor: Aravind Musuluri, Houston, TX (US)

(21) Appl. No.: 17/155,071

(22) Filed: Jan. 21, 2021

Related U.S. Application Data
(60) Provisional application No. 62/963,975, filed on Jan. 21, 2020.

(51) Int. Cl. B60W 40/09; B60W 50/14; G01C 21/36; G01C 21/34

(52) U.S. Cl. CPC B60W 40/09; G01C 21/3484; G01C 21/3617; B60W 50/14

(57) ABSTRACT

Method and systems for evaluating recorded data of a driver's operation of a motor vehicle are provided. The method includes, at the end of a current trip conducted by a vehicle, determining for at least one current trip value position and/or performance of the current trip value when the current trip value is compared with the corresponding trip values from similar historical trips and notifying a driver of the vehicle of the position and/or performance of the current trip value.

### CROSS REFERENCE TO RELATED APPLICATION

This application claims priority to U.S. Provisional Application Ser. No. 62/963,975 entitled System and Method for Evaluating Recorded Data of a Driver's Operation of a Vehicle filed on Jan. 21, 2020, which is incorporated herein by reference.

### TECHNICAL FIELD

The present disclosure pertains to a method and apparatus for evaluating recorded data of a driver's operation of a motor vehicle. More particularly, the present disclosure pertains to recording and evaluating vehicle current trip data in relation with historical similar trips by the same vehicle. The evaluation may provide the driver with valuable insights that can be helpful with future trips.

### BACKGROUND

A driver planning a trip is faced with many choices. For example, there may be several alternate routes for the trip. The driver may start his trip immediately or delay his trip. Depending on his choices for the trip the driver faces different external driving conditions such as school zones, road conditions, traffic etc. For example, sometimes starting a trip even a few minutes early may save considerable amount of time for the driver because of less traffic during the trip. Further, during the trip the driver may prefer to optimize some parameters over others. For example, a driver may be flexible with the start time for a trip and prefers lowest possible time for the trip. Thus, a driver facing several choices may not know the best choice that will optimize his desired parameters for the trip.

As an example, an employee might make several trips in a vehicle between his/her home and office during the course of his/her employment. If during one of these trips the time taken for the trip is lowest among all the trips undertaken thus far between the home and the office and the employee is informed that the time taken for the current trip is the least among all other similar trips, the employee might decide to start at the same time and take the same route as the current trip for any future trips in order to save time commuting from the home to the office. Similarly, if a current trip from the home to the office took longer time than historical trips from the home to the office, the employee may not make the same trip choices as the current trip for any future trips from the home to the office.

Thus, a system and method that helps a driver plan his/her future trips by providing feedback to the driver about the current trip is desired. Ideally, such a system or method would integrate with systems or components of the vehicle and requires no additional input from the driver. In addition, such a system or method would ideally be flexible to allow drivers the ability to customize data to only that information desired by that particular driver.

### SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

According to an embodiment, a method for evaluating recorded data of a driver's operation of a motor vehicle is provided. The method includes, determining start and end locations of a current trip conducted by the vehicle by detecting start of the current trip and end of the current trip, calculating trip value(s) of the current trip based on input from at least one sensor measured from detecting the start of the current trip to detecting the end of the current trip, selecting similar historical trip(s) conducted by the vehicle consisting of the same start and end locations as the current trip, determining for at least one current trip value position and/or performance of the current trip value when the current trip value is compared with the corresponding trip value(s) from similar historical trip(s), and notifying a driver of the vehicle of the position and/or performance of the current trip value.

In another embodiment, the driver may be notified only if the position of current trip value is first or last.

In another embodiment, at least one of the current trip value, the position or the performance may be highlighted if the position current trip value is first or last.

In another embodiment, if the position of the current trip value is not first, notifying the driver of trip information related to the similar historical trip with first position for the corresponding trip value.

In another embodiment, one or more trip values of the current trip are ignored based on a driver preference.

In another embodiment, historical trip(s) conducted by the vehicle from the end location to the start location are also considered similar to the current trip.

In yet another embodiment, the driver is notified of evaluated data before the driver exits the vehicle after the completion of the trip.

In another aspect of the present disclosure is provided with a system comprising of processing hardware and memory configured to perform the functions and operations associated with the above disclosed methods.

### BRIEF DESCRIPTION OF THE DRAWINGS

The drawings described herein are for illustration purposes only and are not intended to limit the scope of the present disclosure in anyway. Throughout the disclosure, like elements are represented by like reference numerals, which are given by way of illustration only and thus are not limitative of the various embodiments.

Other objects and advantages of the present disclosure will become apparent to those skilled in the art upon reading the following detailed description of the preferred embodiments, in conjunction with the accompanying drawings, wherein:

FIG. 1 is a simplified diagram of an exemplary system for vehicle trip data collection and analysis.

FIG. 2 is a flow chart illustrating an exemplary method for analyzing vehicle trip data.

FIG. 3 is an exemplary user interface screen of the disclosure displaying the result of analyzing current trip with similar historical trips.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

Trip, as the term is used herein, is any driving activity by a vehicle from the time the vehicle starts operating to the time vehicle stops operating. Note that the first time vehicle stops operating after the start of a trip, the trip ends. For a trip, the location where the vehicle starts operating is the start location of the trip and where the vehicle stops operating is the end location of the trip.

Two trips are similar if they have same start and end locations. For trips that are similar, a value of one trip can be compared with a corresponding value of the other trip.

In one embodiment, a trip from a start location to an end location is also similar to trip(s) from the end location to the start location. In yet another embodiment, a trip from a start location to an end location is also similar to trip(s) from the end location to the start location only if the distance traveled during the trip is greater than a predetermined distance (for example, greater than 100 miles).

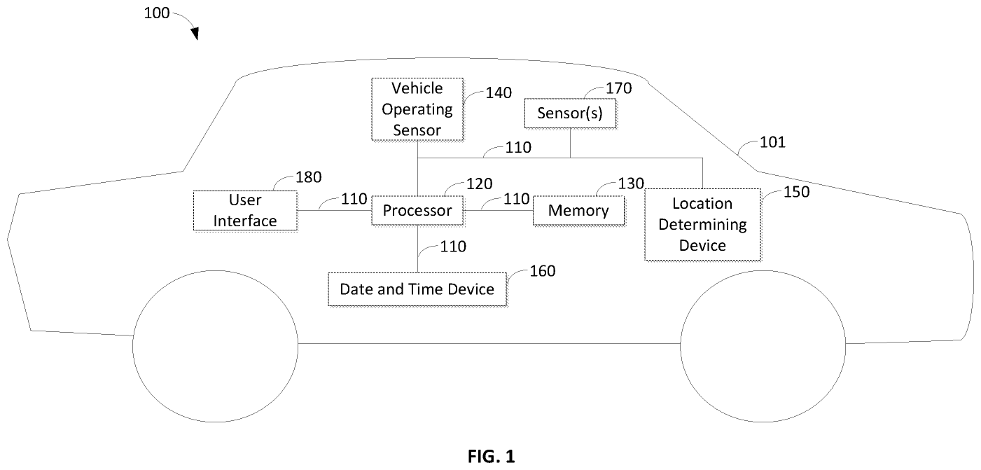

FIG. 1 is a block diagram of an exemplary system 100 for recording and evaluating recorded data of a driver's operation of a motor vehicle. In an exemplary embodiment, system 100 is implemented in a vehicle 101 and suitably includes a processor 120 having a first input coupled to memory module 130 for receiving instructions and/or retrieving stored values, a second input coupled to vehicle operating sensor 140 for receiving an indication of vehicle operating state, a third input coupled to location determining device 150 for receiving geographic location, a fourth input coupled to date and time device 160 for receiving date and time information, a fifth input coupled to sensor(s) 170, and a sixth input coupled to user interface 180 to receive input from a driver. Processor 120 has a first output coupled to memory module 130 for storing instructions and/or values, and a second output coupled to user interface 180 to present information to a driver.

In the exemplary embodiment, system 100 may include a bus 110. Bus 110 may include a path that permits communication among the components of system 100.

In the exemplary embodiment, processor 120 is any type of device, or multiple devices, capable of manipulating or processing information.

In the exemplary embodiment, sensor(s) 170 may be any devices that generate vehicle data which can be used to calculate trip values. Such sensors may include, but are not limited to, odometer, fuel gauge device, etc. Note that all input devices are also sensors. Trip values for a trip may include, but are not limited to, distance traveled, time taken, average speed, number of brakes applied, fuel efficiency, etc. Note that a trip value for a trip may be calculated from vehicle data generated by one sensor or more than one sensor. For example, while distance traveled trip value may be calculated using odometer data, average speed trip value may be calculated from odometer and date and time input device 160 data.

In the exemplary embodiment, location determining device 150 is preferably embodied as a global positioning system receiver. Data from location determining device 150 includes geographic location coordinates. In one embodiment, location determining device 150 additionally comprises of a map service which ties geographic location coordinates to a physical address. Location determining device 150 provides data to processor 120 to find start and end locations for a trip.

In the exemplary embodiment, vehicle 101 is operating if vehicle operating sensor 140 detects the engine of vehicle 101 is in on state and vice versa. In this exemplary embodiment processor 120 determines start and end of a trip by using vehicle operating sensor 140. Note that vehicle operating sensor 140 may detect vehicle operating state in a variety of ways. For example, in other embodiments, vehicle operating sensor 140 may detect vehicle operating state based on a characteristic of vehicle 101, such as position of gear rod, key position in an ignition switch, position of engine start button, etc.

In a preferred embodiment, processor 120 may ignore intermediary stop(s)/start(s) (for example, in the middle of a road, at a rest area or at a gas station) based on input from location determining device 150. For example, during a trip if vehicle 101 stops operating and location determining device 150 determined the location of the stop as a gas station, then processor 120 ignores the stop at the gas station and the trip continues until vehicle 101 stops again. In yet another embodiment, a driver may designate a stop/start as intermediary stop/start and processor 120 ignores the stop/start.

In the exemplary embodiment, processor 120 uses date and time device 160 in at least two ways. First, processor 120 uses date and time device 160 to determine trip information such as start and end time and date for each trip. Second, processor 120 uses date and time device 160 data to calculate trip values such as duration of trip, average speed etc.

In the exemplary embodiment, user interface 180 allows communication between a driver and system 100. At the end of a trip, processor 120 compares current trip values with corresponding values from similar historical trips to determine position and/or performance of the current trip value. The position and/or performance may be presented to the driver through user interface 180. Ideally, this information is communicated to the driver immediately after the end of the current trip. User interface 180 may communicate with the driver using indicators such as visual, sounds, or vibrations. In this manner user interface 180 may display text and images, produces an audible voice prompt, or produces a tactile stimulation.

In a preferred embodiment, recording and/or evaluating of vehicle trip data by system 100 may be based upon one or more driver preferences. For example, a driver may specify through user interface 180 trips shorter than 10 meters should not be recorded and evaluated. In another example, a driver may specify through user interface 180 that only trips starting at home and ending at office should be recorded and evaluated. In yet another example, a driver may specify through user interface 180 that the current trip should be ignored. Note that system 100 may utilize a variety of driver preferences.

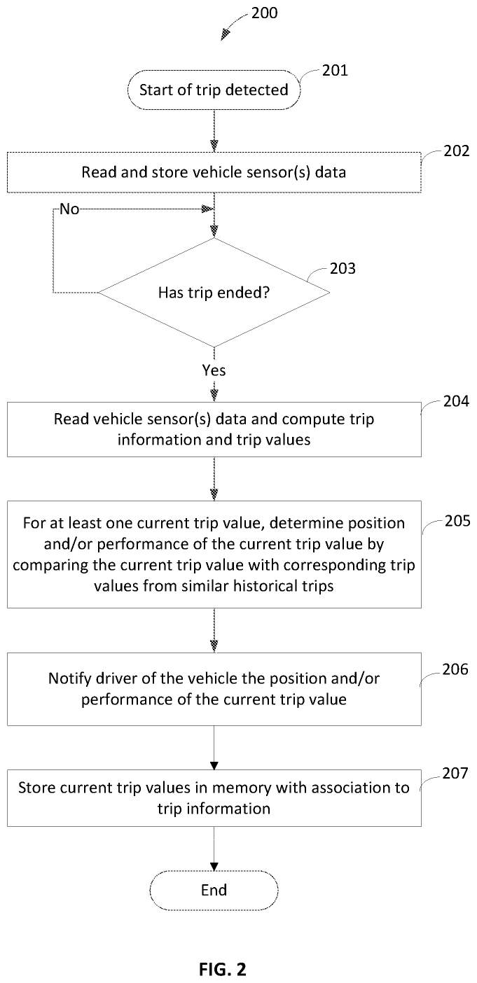

Turning now to FIG. 2, there is shown a flowchart 200 for recording and evaluating vehicle 101 (FIG. 1) data. The steps or functionality of flowchart 200 may be stored in memory module 130 (FIG. 1) and accessible by processor 120 (FIG. 1). In step 201, flowchart 200 begins when processor 120 detects start of a trip. This may occur upon processor 120 receiving a signal from vehicle operating sensor 140 (FIG. 1) that vehicle 101 engine state changed to on from off. In step 202, processor 120 may read and store one or more vehicle sensor 170 (FIG. 1) data in memory module 130. The sensor data may later be used by processor 120 for calculating trip values and trip information. In step 203, processor 120 monitors vehicle sensor(s) to determine if the trip has ended. This may occur upon processor 120 receiving a signal from vehicle operating sensor 140 that vehicle 101 engine state changed to off from on. If in step 203 processor 120 determines that the trip has ended, execution then moves to step 204. In step 204, immediately after determining that the trip has ended, processor 120 may read one or more vehicle sensor 170 data and compute trip information and trip values from the vehicle sensor data and the data stored in memory module 130 in step 202. Trip information may include, but not limited to, start and end locations of the trip, start and end time and date of the trip, trip route, etc. In step 205, for at least one current trip value, processor 120 determines position and performance of the current trip value by comparing the current trip value with corresponding trip values from similar historical trips by vehicle 101 stored in memory module 130. In step 206, a driver of the vehicle 101 may be notified the position and/or performance of the current trip value. In step 207, the current trip values are stored in memory module 130 with association to trip information.

In one embodiment, the system 100 (FIG. 1) may permit external access to the data stored in step 207 (e.g., via a USB or wireless interface) so that such data can be exported to a device separate from the vehicle 101 (FIG. 1), such as a personal computer or diagnostics system. This data may be exported in a variety of file formats, for example as plain text, as a spreadsheet, as a database, etc.

In other embodiments, processor 120 (FIG. 1) may perform the steps or functions described in method 200 in a different order or may execute functions simultaneously. Additional functions may be added or removed, and method 200 may be part of a larger process, or multiple processes.

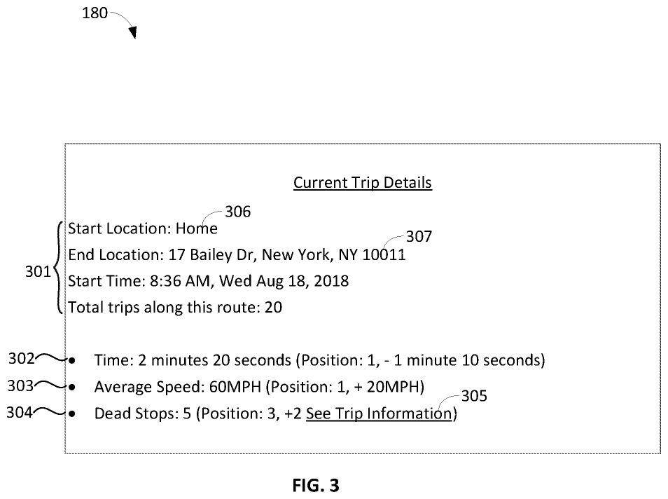

FIG. 3 shows an exemplary user interface 180 (FIG. 1) of system 100 (FIG. 1) displaying the result of analyzing an exemplary current trip with similar historical trips. In this example, for current trip, trip information 301 along with lines 302-304 consisting of trip values and their corresponding position and performance are displayed to the driver on user interface 180.

A driver through user interface 180 (FIG. 1) may pre-assign identifiers to physical addresses and the identifiers stored in memory module 130 (FIG. 1). If an identifier is pre-assigned by the driver to an address, system 100 (FIG. 1) may use the identifier instead of the physical address. In the exemplary user interface 180, identifier Home 306 is used for the start location instead of an actual physical address.

Line 302 suggests a time of 2 minutes 20 seconds for completion of the trip. In line 302, the position of 1 is determined by arranging the current trip time value and the time values (not shown) from the other 19 (see trip information 301) similar historical trips in ascending order. The performance of minus 1 minute 10 seconds is determined by subtracting historical best time value (smallest time value among the other 19 similar historical trips) from the current time value. Line 303 suggests an average speed of 60 MPH for the trip. The position of 1 is determined by arranging the current trip average speed value and the average speed values (not shown) from the other 19 similar historical trips in descending order. The performance of plus 20 MPH is determined by subtracting historical best average speed value (highest average speed value among the other 19 similar historical trips) from the current average speed value. Line 304 suggests 5 dead stops during the current trip. The position of 3 is determined by arranging the current trip dead stops value and the dead stops values (not shows) from the other 19 similar historical trips in ascending order. The performance of plus 2 is determined by subtracting historical best dead stops value (lowest dead stops value among the other 19 similar historical trips) from the current dead stops value. By clicking or selecting See Trip Information 305 the driver may see the trip information for the similar historical trip with best dead stops value.

Thus, if the driver prefers to save time or high average speed for a trip between home 306 and end location 307, the driver may emulate the current trip and if the driver wishes to avoid dead stops for a trip between home and end location 307, the driver may emulate the trip with trip information 305.

Note that depending on the type of trip values, trip values may be arranged in ascending or descending order to determine position of trip values.

On user interface 180, the color of lines 302 and 303 is green. Lines 302 and 303 are highlighted because the position of the current trip values on these lines is first. In other embodiments, if the position of the current trip value is first or last, instead of highlighting the entire line as in exemplary user interface 180, current trip value and/or position and/or performance may be highlighted. Note that the highlighting may not be limited to color. In other embodiments, highlighting may include, but not limited to, font weight, font family, background color, borders, shading, text decorations etc.

Note that when this is the first trip between a start location and an end location, then the position of trip values is first and there may not be any performance values.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method for evaluating recorded data of a driver's operation of a motor vehicle, the method comprising:
(a) determining whether start of a current trip is detected;
(b) in response to detecting start of the current trip, determining start location of the current trip;
(c) determining whether end of the current trip is detected;
(d) in response to detecting end of the current trip, determining end location of the current trip;
(e) calculating trip value(s) of the current trip based on input from at least one sensor measured from detecting the start of the current trip to detecting the end of the current trip;
(f) selecting similar historical trip(s) conducted by the vehicle consisting of the same start and end locations as the current trip;
(g) determining for at least one current trip value position and/or performance of the current trip value when the current trip value is compared with corresponding trip values from the similar historical trip(s); and
(h) notifying a driver of the vehicle the position and/or performance of the current trip value.

2. The method of claim 1, further comprising notifying the driver only if the position of the current trip value is first or last.

3. The method of claim 1, wherein if the position of the current trip value is first or last, highlighting at least one of the current trip value, the position or the performance.

4. The method of claim 1, wherein if the position of the current trip value is not first, notifying the driver of trip information related to the similar historical trip with first position for the corresponding trip value.

5. The method of claim 1, further comprising ignoring one or more trip values of the current trip based on a driver preference.

6. The method of claim 1, wherein historical trip(s) by the vehicle from the end location to the start location are also considered as similar to the current trip.

7. The method of claim 6, wherein historical trip(s) by the vehicle from the end location to the start location are considered as similar to the current trip if the distance traveled during the current trip is greater than a predetermined distance.

8. The method of claim 1, wherein the driver is notified before the driver exits the vehicle after the completion of the trip.

9. A system for managing data of a vehicle, the system comprising: a processor; a memory, having instructions stored thereon, that when executed by the processor, causes the processor to perform the operations, the operations comprising:
(a) determining, by a processor, whether start of a current trip is detected;
(b) in response to detecting start of the current trip, determining start location of the current trip;
(c) determining, by the processor, whether end of the current trip is detected;
(d) in response to detecting end of the current trip, determining end location of the current trip;
(e) calculating, by the processor, trip value(s) of the current trip based on input from at least one sensor measured from detecting the start of the current trip to detecting the end of the current trip;
(f) selecting, by the processor from memory, similar historical trip(s) conducted by the vehicle consisting of the same start and end locations as the current trip;
(g) determining, by the processor, for at least one current trip value position and/or performance of the current trip value when the current trip value is compared with corresponding trip values from the similar historical trip(s); and
(h) notifying a driver of the vehicle the position and/or performance of the current trip value.

10. The system of claim 9, further comprising notifying the driver only if the position of the current trip value is first or last.

11. The system of claim 9, wherein if the position of the current trip value is first or last, highlighting at least one of the current trip value, the position or the performance.

12. The system of claim 9, wherein if the position of the current trip value is not first, notifying the driver of trip information related to the similar historical trip with first position for the corresponding trip value.

13. The system of claim 9, further comprising ignoring one or more trip values of the current trip based on a driver preference.

14. The system of claim 9, wherein historical trip(s) by the vehicle from the end location to the start location are also considered as similar to the current trip.

15. The system of claim 14, wherein historical trip(s) by the vehicle from the end location to the start location are considered as similar to the current trip if the distance traveled during the current trip is greater than a predetermined distance.

16. The system of claim 9, wherein the driver is notified before the driver exits the vehicle after the completion of the trip.
